(19) United States
(12) Patent Application Publication
(10) Pub. No.: US 2013/0336380 A1
(43) Pub. Date: Dec. 19, 2013

(54) Power Optimization for Compression in Wireless Transmissions

(71) Applicants: Murat Mese, RPV, CA (US); Brima Ibrahim, Laguna Hills, CA (US)

(72) Inventors: Murat Mese, RPV, CA (US); Brima Ibrahim, Laguna Hills, CA (US)

(73) Assignee: BROADCOM CORPORATION, Irvine, CA (US)

(21) Appl. No.: 13/525,574

(22) Filed: Jun. 18, 2012

(51) Int. Cl. H04W 52/02; H04N 7/26

(52) U.S. Cl. 375/240.02; 375/E07.173

(57) ABSTRACT

An exemplary embodiment comprises a compression regulator component configured to select a compression rate that will minimize the total power value used by the wireless device in wirelessly transmitting a data stream over a current network channel, and a compression module configured to compress the data stream at the compression rate selected.

### TECHNICAL FIELD

The present disclosure is generally related to wireless data transmissions.

### BACKGROUND

Due to the high power consumption of wireless data transmissions under recent wireless transmission standards, data, such as video and images, are compressed before wireless transmission to reduce the size of the data being transmitted. However, introduction of new wireless transmission standards are reducing the power consumption of wireless data transmissions.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram illustrating one embodiment of an endpoint device in accordance with the present disclosure.

FIG. 2 is a diagram showing a detailed view of an embodiment of an example communication device in accordance with the present disclosure.

FIG. 3 is a flowchart diagram of a method of setting a compression level to optimize power or energy levels according to an embodiment of the present disclosure.

FIG. 4 is a diagram providing graphs of relative power consumption of compression rate versus transmission power in accordance with the present disclosure.

FIG. 5 shows a block diagram of an example electronic device featuring power optimization techniques by automatically adjusting a compression rate, according to an embodiment of the present disclosure.

### DETAILED DESCRIPTION

Various embodiments of the present disclosure are discussed in detail below. While specific implementations are discussed, it should be understood that this is done for illustration purposes only. A person skilled in the relevant art will recognize that other components and configurations may be used without parting from the spirit and scope of the disclosure.

Ethernet networks have become ubiquitous in their deployment across corporate and residential markets. Ethernet networks have therefore benefited from the significant reduction in costs afforded by the growing economies of scale. Levels of network traffic are expected to increase, meaning that typical network connections will increasingly support 1000BASE-T, 10 GBASE-T, and beyond. Typical network connections also include wireless network links as well.

The limitations of network resources are often viewed in terms of bandwidth as an increasing number of applications compete for the same network resources. Some applications produce “bursty” traffic with high bandwidth, such as in the transfer of large files. Other applications involving audio/video (AV) traffic can produce a distributed stream of data. Regardless of the type of traffic and application, one of the ways of dealing with a bandwidth-limited situation is to use some form of compression to lower the amount of data that is transmitted over the network.

While compression does enable the traffic to fit into the available bandwidth, compression does come at a cost in terms of consuming a wireless device's battery life or power supporting device functionality. In general, the greater the level of compression, the greater the level or amount of power that is consumed and used for the compression function. Accordingly, one of the major issues in budgeting use of battery power is the identification of the appropriate level of compression to be used. Clearly, with respect to compression resources, the transmission of uncompressed traffic would be ideal in saving battery power, as battery resources are not used for compression. However, the transmission of uncompressed traffic over a data network, in turn, increases the amount of battery power used during the transmissions, since the amount of data being sent is more than if the traffic was compressed. Therefore, with respect to transmission resources, the transmission of compressed traffic would be ideal in saving battery power, as less battery resources are used to transmit compressed traffic.

For compression of video, the power consumption needed may be due to accessing device memory at high speeds, where the interface to the memory would consume power and the memory itself would consume memory. There might also be a tight latency constraint on a video encoding/transmission/decoding system which would prompt much faster access to the memory and increase the power consumption of the wireless device.

Another constraint to consider is that wireless transmission standards have previously attempted to reduce the required bandwidth used in transmission channels. Therefore, in conventional applications, the level of compression is set to compress outgoing traffic as much as possible. This is due to the power consumption of conventional wireless transmissions being at a significantly high level. However, with the introduction of new wireless standards, such as 60 GHz wireless transmission (e.g., IEEE 802.11 ad and/or WiGig Alliance standards), the power consumption of wireless transmission has been lowered—they work at a short range and do not cause interference to other simultaneous users of the same kind. Hence, the abundance of available bandwidth makes sending lighter/not at all compression of data or video a better alternative.

Accordingly, embodiments of the present disclosure set a compression level to optimize both video coding and wireless transmission power or energy levels. In some scenarios, rather than compressing the video as much as possible, it may make sense to do a light compression or no compression at all to reduce the power consumption spent in compressing the video to be sent over power efficient wireless links. Therefore, it is a feature of an embodiment of the present disclosure that available compression levels can be set based on reliable indicators of network or channel conditions. In accordance with one embodiment, the usage of reliable indicators of network conditions enable a wireless device to use lower levels of compression without concern that the resulting power-induced level of compression will produce an overall increase in total power consumption.

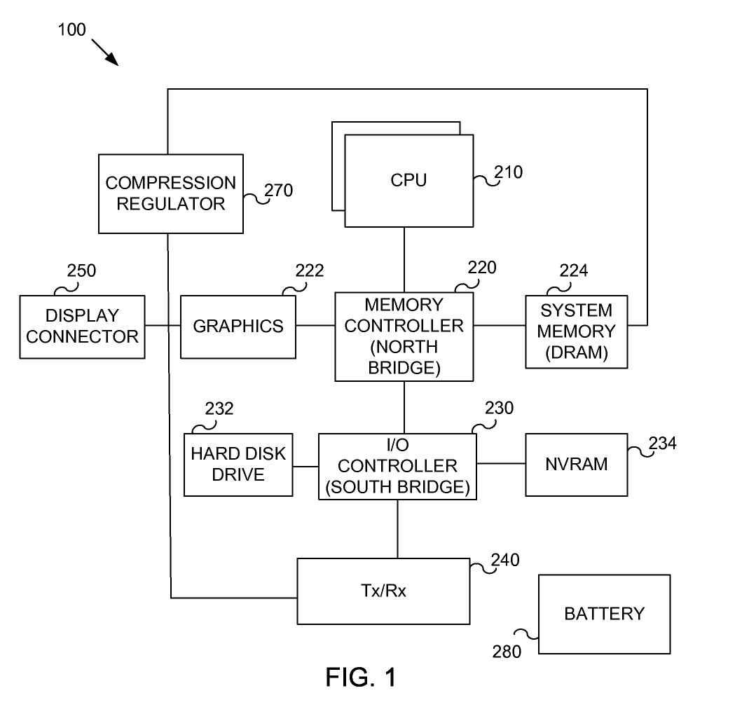

FIG. 1 illustrates one embodiment of an endpoint device, such as a wireless communication device. In accordance with the present disclosure, a communication data session between receiving and sending parties over a network channel may involve endpoint devices similar to that depicted in FIG. 1. In the illustration of FIG. 1, the endpoint device 100 includes computing components such as CPU(s) 210, memory controller (north bridge) 220, and I/O controller (south bridge) 230. As illustrated, memory controller 220 can be coupled to graphics subsystem 222 and main system memory 224. I/O controller 230, on the other hand, can also be coupled to various components, including hard disk drive 232 and nonvolatile RAM (NVRAM) 234. A compression regulator 270 comprises a component that is configured to automatically apply adjustments to a compression rate utilized by the graphics subsystem 222 or other component which implements a data compression algorithm for data that is to be transmitted. The compression regulator 270 may regulate the compression rate based on input provided from a transmitter/receiver (Tx/Rx) component 240 (e.g., LAN device or peer-to-peer device) and conserve power of the battery source 280 of the endpoint device 100.

As FIG. 1 further illustrates, I/O controller 230 is also in communication with transmitter/receiver 240. In general, transmitter/receiver 240 provides networking functionality such as that provided by a conventional network interface card (NIC). As transmitter/receiver 240 can be designed to support one or more Ethernet ports, transmitter/receiver (Tx/Rx) 240 would include one or more media access controllers (MACs), a PCI Express bus interface, on-chip buffer memory, and one or more integrated physical layer (PHY) transceivers. In one embodiment, transmitter/receiver 240 is compliant within a proposed draft of the 802.11ad standard and/or WiGig Alliance standards.

It is noted that the compatibility of the 802.11n functionality is backward compatible and forward compatible with the previous and subsequent versions of 802.11 (such as 802.11n). As an example, 802.11ad is a draft proposal for a next generation of the 802.11 standard; the functionality of the proposed 802.11ad standard will be compatible with the proposed drafts of 802.11 ad.

As further illustrated, the endpoint device 100 includes a display connector 250 (e.g., DisplayPort, HDMI, DVI, analog, etc.). Display connector 250 enables the endpoint device 100 to display video content (e.g., HDTV) or any other multimedia traffic on an external display device coupled to display connector 250. The video signal is also coupled to transmitter/receiver 240. Additionally, the endpoint device 100 and components of the endpoint device 100 are provided power from the battery source 280. To conserve power of the battery source 280, an optimal compression rate can be selected in accordance with the present disclosure by the compression regulator component 270.

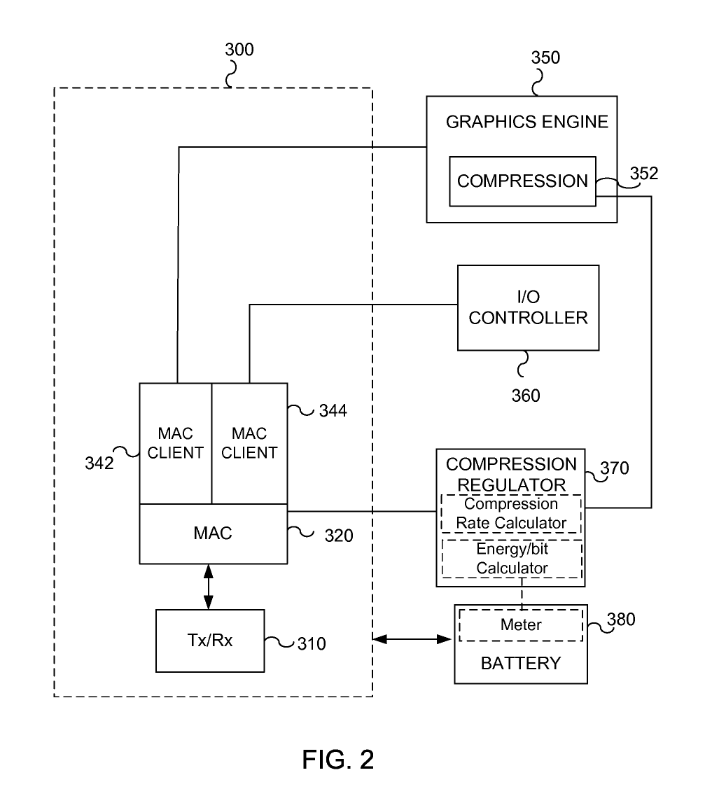

FIG. 2 shows a detailed view of an embodiment of an example wireless communication device 300 in accordance with the present disclosure. Accordingly, a communication data session between receiving and sending parties over a network channel may involve communication devices similar to that depicted in FIG. 2. As illustrated, communication device 300 interfaces with graphics engine 350 and I/O controller 360. Interfaces with graphics engine 350 and I/O controller 360 are enabled via MAC clients 342 and 344, respectively. Data signals that are passed to/from MAC clients 342 and 344 are facilitated by MAC 320 and transmitter/receiver (Tx/Rx) 310.

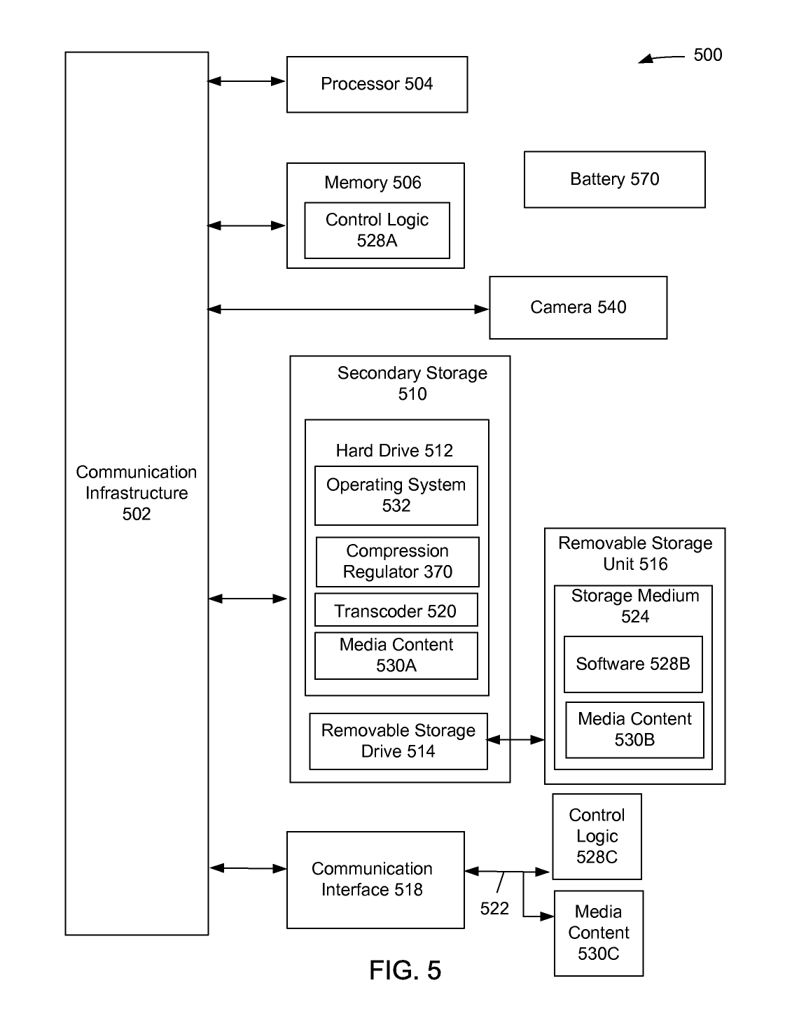

As illustrated, graphics engine 350 includes compression module 352, in addition to encoder and decoder components (not shown). In various embodiments, compression module 352 can be implemented in hardware, software, or firmware and produce variable or fixed forms of compression. In this configuration, graphics engine 350 can be applied to native video or encapsulated HDMI, DisplayPort, DVI, etc. Functionality of the compression module 352, in some embodiments, may be included within a transcoder 520 (FIG. 5). Encryption can also be used as needed by the particular implementation. In addition to handling best effort data traffic, I/O controller 360 can also be used for latency-sensitive audio or other latency-sensitive multimedia traffic. As such, I/O controller 360 could also include compression functionality as well.

A compression regulator 370 comprises a component that is configured to automatically apply adjustments to a compression rate utilized by the compression module 352. The compression regulator 370 may regulate the compression rate based on input provided from MAC 320 of the communication device 300 and conserve power of the battery source 380. In particular, based on network strength and/or power indicators obtained from communication device 300, an energy/bit value is calculated by an energy/bit calculator of the compression regulator 370. The calculated value represents an amount of energy needed to transmit a bit of data under current network conditions. Then, a compression rate calculator may determine an optimal compression rate to be used under the current network conditions. The compression regulator 370 provides the determined compression rate to the compression module 352.

In an alternative embodiment, I/O controller 360 is designed to only handle best effort data traffic, while graphics engine 350 is a multimedia engine designed to handle all multimedia traffic. In this arrangement, the multimedia engine can receive such traffic from the north bridge or south bridge or from any other source either directly or indirectly, including a DisplayPort or HDMI interface associated with the graphics engine.

As should be appreciated, the example embodiments of FIGS. 1 and 2 are not intended to be exhaustive or limiting. Various other memory controller and I/O controller configurations can be used with the principles of the present disclosure. It is a feature of the present disclosure that an identified indication of network conditions can be used in determining how best to use the power resources towards data compression. As will be described in greater detail below, knowledge of network conditions would enable devices to choose an appropriate level of compression.

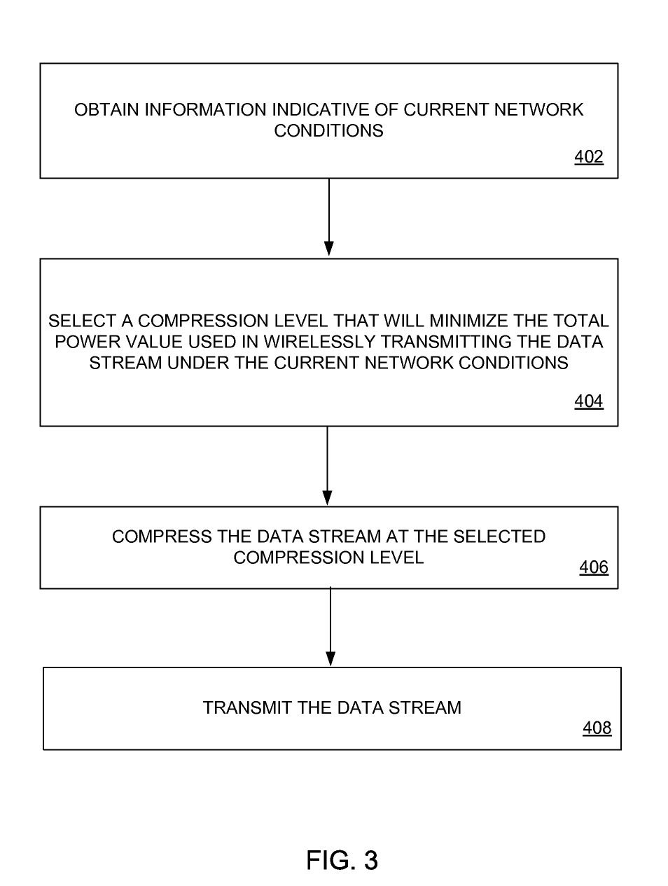

In accordance with an embodiment of the present disclosure, information corresponding to network conditions is used to determine how best to leverage available network resources through the selective utilization of computing resources in endpoint devices 100. To illustrate this impact, reference is now made to the flowchart of FIG. 3. As illustrated, one embodiment of a process of setting a compression level to optimize power or energy levels begins with obtaining (402) information indicative of current network conditions by a compression regulator component 370. In various scenarios, a compression level can be determined based on consideration of a total power value to be used in wirelessly transmitting a stream of data under the current network conditions. A compression level or rate is then selected (404) by the compression regulator component 370 that will minimize the total power value used in wirelessly transmitting the stream of data under the current network conditions. Next, the data stream is compressed (406) at the selected compression level/rate and a connection is requested between endpoint devices, where the data stream data is transmitted (408) over the connection. In various embodiments, this compression can be executed in hardware or software. Additionally, the principles of the present disclosure can be applied to any network carrying traffic that can be streamed and/or compressed.

Compression regulator component 370 comprises a component that is configured to automatically apply adjustments to the compression rate value used to control compression of media content by compression module 352. The compression regulator component 370 is configured to automatically adjust the compression rate value based on one or more conditions that are discernible to the component 352. In particular, the compression regulator component 370 is configured to automatically adjust the compression rate based on at least a condition of a network environment or channel in which an endpoint device 100 is operating. For example, the network condition may comprise a received power, SNR, etc. obtained from signals received from a network access point, base station, endpoint device 100, etc. From network condition information, an estimate of energy needed to perform transmissions over the network may be calculated and gauged against stored/determined values of estimates of energy needed to perform compression or coding of data signals.

Parameters, such as, but not limited to, received channel power indicator (RCPI), received signal strength indicator (RSSI), can be provided by a communication device, including a LAN device or a peer-to-peer (P2P) device, from received signals over a network channel and used to calculate energy/bit values by the compression regulator 270, 370. Calculations of the energy/bit values may be obtained periodically according to a set schedule or may be obtained dynamically or on the fly (e.g., responsive to registering the endpoint device with a network access point, responsive to receiving at least one of a request to receive a stream of video data or a request to transfer a stream of video data, etc.)

However, these examples are not intended to be limiting, and the operation of compression regulator component 370 may be based on numerous other network or device conditions. For example, in one embodiment, power consumption of an endpoint device 100 may be determined, via an internal power consumption meter coupled to a battery or power source 380, by measuring a voltage drop across a sensor resistor embedded in a battery or power source 380 during a compression operation or a transmission operation. These measurements may then be provided to the compression regulator 370 and used to calculate compression rate adjustments.

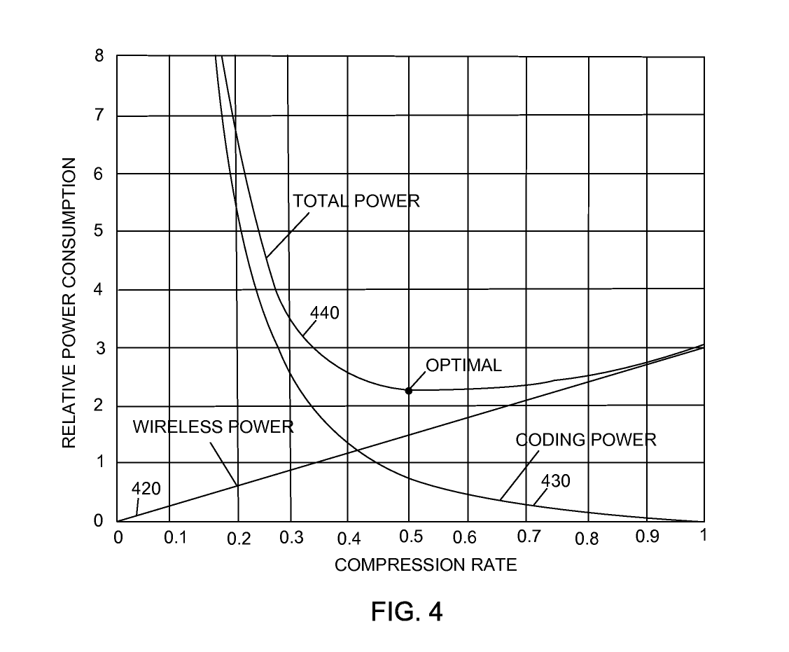

As shown in FIG. 1, compression regulator 270, 370 also communicates with a memory 224 that stores one or more measurements or data points. In one implementation, memory 224 stores a look-up table of energy values. Energy values per compression rate values may be stored in such a table that characterizes an amount of battery power that is consumed when performing particular compression rate levels. Referring now to FIG. 4, a chart is provided of graphs of relative power consumption of compression rate versus transmission power. The horizontal axis shows the compression rate, where 1.0 corresponds to no video compression and 0.1 corresponds to 1:10 video compression. The vertical axis shows relative power consumption used to perform either wireless transmissions or compression coding. As an example, according to the graph, sending uncompressed data consumes 3 units of power during transmission, whereas compressing 1:5 requires over 6 units of power during transmission.

Graph 402 represents power needed to perform wireless transmissions at the various compression rates. At the left end of the graph 420, wireless power rate of 0.5 units is consumed to transmit data having been compressed at a compression rate of 0.3. For comparison, it is noted that a 100 MB block at a 0.3 compression rate is 30 MB. At the right end of the graph 420, a wireless power rate of 3 units is consumed for a compression rate of 1.0. It is noted that a 100 MB block at a 1.0 compression rate is 100 MB. For comparison, it is further noted that graph 420 is a linear line and therefore may be constructed by storing two data points for the line and then interpolating points contained on the line between the two data points.

Next, graph or curve 430 represents power needed to perform compression operations at the various compression rates. At the left end of the graph 430, a power rate of 6 units is consumed to compress data at a compression rate of 0.2. For comparison, it is noted that a 100 MB block at a 0.2 compression rate is compressed to 20 MB. At the right end of the graph 430, a power rate of less than 0.4 units is consumed to compress data at a compression rate of 0.7. For comparison, it is noted that a 100 MB block at a 0.7 compression rate is compressed to 70 MB.

By adding the relevant values represented in graph 420 and graph 430 together, graph 440 may be produced. Graph 440 represents the total power consumed to perform compression operations and wireless transmission operations at the various compression rates. As shown in the figure, the optimal point for compression is around 1:2 compression (compression rate of 0.5), where the optimal point depends on the relative power used by the transmitter/receiver 240, 310 and the video coding performed by compression module 352. Therefore, compression regulator 270, 370 determines the amount by which the compression rate or code rate should be adjusted to achieve the optimal point by comparing the relative values of power consumption experienced by the endpoint device 100. In various embodiments, the power consumption values being considered may be fixed values stored in memory or may be dynamic values calculated based on current network or device conditions.

Consider that in wireless data networks, access points transmit beacon messages to advertise their availability and provide a signal that clients can use to measure the quality of a radio link. In some embodiments, the compression regulator 270, 370 may use the access point's beacon message to gauge the received signal quality (i.e., Signal/Noise ratio) and estimate the relative power consumption values involved with transmitting on a current network channel. The compression regulator 270, 370 may also take into account the type of wireless technology being utilized by the access point. The communication device 300 may also receive channel measurements from a receiving device when the communication device 300 sends any data. From these measurements, the compression regulator may determine the required transmit power to send a data unit wirelessly.

As it has been mentioned earlier, the cost to send the data over wireless interface for one standard or technology may be more than another wireless standard or technology (e.g., 60 GHz wireless standard). Accordingly, a compression regulator 270, 370 may take into account a wireless technology type (e.g., the fact that a current network supports 60 GHz) before selecting to lower a compression rate. In particular, with 60 GHz, the energy needed to send a data unit is much lower than earlier standards. Therefore, it may not always be in the best interest of power conservation to compress data at a maximum level.

For a current network channel, the energy cost to transfer a certain amount of data depends on the wireless technology and network condition of the channel. The energy cost for an endpoint device 100 to transfer (similarly for receiving) M bits of data through a wireless channel, E, can be calculated as

E=EO+EB*M,

where EO is the overhead for setting up a connection and EB is the energy consumption per bit. Both EO and EB depend on the wireless technology, network condition, and the mobile device. For a given wireless technology, EO and EB can often be estimated for a given device, if the network condition is also known. For instance, network technologies differ in their coverage and data rate. Accordingly, a network condition can indicate the signal strength and achievable data rate of the network. Therefore, in order to determine power consumption values involved with transmitting over the current network, the network condition (e.g., received signal strength, received SNR, etc.) may be obtained.

Alternatively, as discussed previously, power consumption values may also be measured internally by the endpoint device 100. For example, in one embodiment, power consumption of an endpoint device may be determined, via an internal power consumption meter, by measuring a voltage drop across a sensor resistor embedded in a battery 380 during a compression operation or a transmission operation. These measurements may then be provided to the compression regulator 370 and used to calculate compression rate adjustments.

FIG. 5 shows a block diagram of an example electronic device featuring power optimization techniques by automatically adjusting a compression rate, according to an embodiment. In embodiments, electronic device 500, such as a wireless device 100, may include one or more of the elements shown in FIG. 5.

As shown in the example of FIG. 5, electronic device 500 may include one or more processors (also called central processing units, or CPUs), such as a processor 504. Processor 504 is connected to a communication infrastructure 502, such as a communication bus. In some embodiments, processor 504 can simultaneously operate multiple computing threads. The electronic device 500 and its respective components may be powered by a battery device 570.

Electronic device 500 also includes a primary or main memory 506, such as random access memory (RAM). Main memory 506 has stored therein control logic 528A (computer software), and data.

Electronic device 500 also includes one or more secondary storage devices 510. Secondary storage devices 510 include, for example, a hard disk drive 512 and/or a removable storage device or drive 514, as well as other types of storage devices, such as memory cards and memory sticks. For instance, electronic device 500 may include an industry standard interface, such a universal serial bus (USB) interface for interfacing with devices such as a memory stick. Removable storage drive 514 represents a floppy disk drive, a magnetic tape drive, a compact disk drive, an optical storage device, tape backup, etc. As shown in FIG. 5, secondary storage devices 710 may include an operating system 532 and transcoder 520.

Removable storage drive 514 interacts with a removable storage unit 516. Removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. Removable storage drive 514 reads from and/or writes to removable storage unit 516 in a well-known manner.

Electronic device 500 further includes a communication or network interface 518 (e.g., communication device 300). Communication interface 518 enables the electronic device 500 to communicate with remote devices. For example, communication interface 518 allows electronic device 500 to communicate over communication networks or mediums 522 (representing a form of a computer useable or readable medium), such as LANs, WANs, WLANs, the Internet, etc. Network interface 518 may interface with remote sites or networks via wired or wireless connections.

Control logic 528C may be transmitted to and from electronic device 500 via the communication medium 522. Any apparatus or manufacture comprising a computer useable or readable medium having control logic (software) stored therein is referred to herein as a computer program product or program storage device. This includes, but is not limited to, electronic device 500, main memory 506, secondary storage devices 510, and removable storage unit 516. Such computer program products, having control logic stored therein that, when executed by one or more data processing devices, cause such data processing devices to operate as described herein, represent embodiments of the present disclosure.

Electronic device 500 may be implemented in association with a variety of types of display devices. For instance, electronic device 500 may be one of a variety of types of media devices, such as a stand-alone display (e.g., a television display such as flat panel display, etc.), a computer, a tablet, a smart phone, a game console, a set top box, a digital video recorder (DVR), a networking device (e.g., a router, a switch, etc.), a server, or other electronic device mentioned elsewhere herein, etc. Media content that is delivered in two-dimensional or three-dimensional form according to embodiments described herein may be stored locally or received from remote locations. For instance, such media content may be locally stored for playback (replay TV, DVR), may be stored in removable memory (e.g. DVDs, memory sticks, etc.), may be received on wireless and/or wired pathways through a network such as a home network, through Internet download streaming, through a cable network, a satellite network, and/or a fiber network, etc. For instance, FIG. 5 shows a first media content 530A that is stored in hard disk drive 512, a second media content 530B that is stored in storage medium 524 of removable storage unit 516, and a third media content 530C that may be remotely stored and received over communication medium 522 by communication interface 518. Media content 530 may be stored and/or received in these manners and/or in other ways.

Video-image camera 540 may include an image sensor device and image processor and/or additional/alternative elements. The video-image camera 540 captures video images, and generates corresponding video data that is output on a video data signal. In an embodiment, the video data signal contains the video data that is output on an image processor output signal, including processed pixel data values that correspond to images captured by the image sensor device. The video data signal may include video data captured on a frame-by-frame basis or other basis. In an embodiment, the video data signal may include video data formatted as Bayer pattern data or in another image pattern data type known in the art.

In accordance with one embodiment, the video data signal may be transmitted using the communication interface 518, where the video data signal may be compressed at a compression rate selected by the compression regulator component 370. In an embodiment, the transcoder 520 may support static functionality to compress a data signal at a compression rate selected by the compression regulator component 370 before the data signal is relayed to the communication interface 518 for wireless or wired transmission.

In an embodiment, a data signal may be transmitted wirelessly from location A to location B with a compression rate r1 selected by the communication device at location A. However, in further transmitting the data signal from location B to location C, a communication device at location B may be configured to select a different compression rate r2 after determining that the compression rate r2 is a more optimal choice for the transmission from location B to location C. Accordingly, the data signal may be transcoded by the communication device at location B in accordance with the selected compression rate r2 and then transmitted to a communication device at location C.

Referring to FIG. 5, use of the compression regulator 370 in accordance with the present disclosure may reduce the power burden on battery 570. Further, control logic 528A may be able to activate a mode (“power saving mode”) in which the compression regulator functionality is activated and an alternative mode in which the compression regulator functionality is deactivated. Activation or deactivation of these modes may be selected by a user of the electronic device, in one embodiment.

Accordingly, embodiments of the present disclosure set a compression level to optimize both video coding and wireless transmission power or energy levels under current network conditions. In some scenarios, rather than compressing the video as much as possible, it may make sense to do a light compression or no compression at all to reduce the power consumption spent in compressing the video to be sent over power efficient wireless links. However, the disclosure is not limited to the compression of only video signals. Rather, any type of data in general may be compressed in accordance with the present disclosure. Further, embodiments can cover or include any system, where pre-conditioning of data is used to lower the total power required to send or receive data transmissions. Such pre-conditioning of data may include joint source/channel coding with a target of minimizing power used in source and channel coding. Current network conditions that affect optimization levels may include a limited bandwidth being computed between a transmitting communication device and receiver.

Certain embodiments of the present disclosure, including the compression regulator component, can be implemented in hardware, software, firmware, or a combination thereof. Some embodiments are implemented in software or firmware that is stored in a memory and that is executed by a suitable instruction execution system. An alternative embodiment can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art.

A software program corresponding to the static condenser can comprise an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments includes embodying the functionality of exemplary embodiments of the present disclosure in logic embodied in hardware or software-configured mediums.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, having thus described various embodiments, at least the following is claimed:

1. A method comprising:
obtaining information indicative of at least one of a current network condition or a current channel condition by a compression regulator component of an endpoint device;
selecting, by the compression regulator component, a compression rate that will minimize the total power value used in wirelessly transmitting a data stream under said at least one of the current network condition or the current channel condition;
compressing the data stream at the compression rate selected; and
wirelessly transmitting the data stream after having been compressed.

2. The method of claim 1, wherein the information indicative of said at least one of the current network condition or the current channel condition is obtained periodically according to a schedule.

3. The method of claim 1, wherein the information indicative of said at least one of the current network condition or the current channel condition is obtained responsive to registering the endpoint device with a network access point.

4. The method of claim 3, wherein the information indicative of said at least one of the current network condition or the current channel condition is obtained responsive to receiving at least one of a request to receive a stream of video data or a request to transfer a stream of video data.

5. The method of claim 1, wherein the compression rate selected indicates that no compression is to be performed.

6. The method of claim 1, wherein the compression rate is selected by considering a total power to be consumed by the endpoint device, wherein the total power to be consumed includes power consumption during wireless transmissions under the current network condition and power consumption during data compression at the compression rate selected, wherein the total power to be consumed at the compression rate selected will minimize the total power consumption used in wirelessly transmitting the data stream under the current network condition.

7. A wireless device comprising:
a compression regulator component configured to select a compression rate that will minimize the total power value used by the wireless device in wirelessly transmitting a data stream over a current network channel;
a compression module configured to compress the data stream at the compression rate selected; and
a communication network device configured to wirelessly transmit the data stream after having been compressed at the compression rate selected.

8. The system of claim 7, further comprising:
an internal power consumption meter configured to determine a current network condition of the current network channel by measuring an amount of power consumed during wireless transmissions over the current network channel.

9. The system of claim 7, wherein the communication network device obtains information indicative of a current network condition of the current network channel.

10. The system of claim 9, wherein the information indicative of the current network condition is obtained periodically according to a schedule.

11. The system of claim 9, wherein the information indicative of the current network condition is obtained responsive to newly registering the wireless device with a network access point.

12. The system of claim 7, wherein the information indicative of a current network condition is obtained responsive to receiving at least one of a request to receive a stream of video data or a request to transfer a stream of video data.

13. The system of claim of claim 7, wherein the compression rate selected indicates that no compression is to be performed.

14. The system of claim 7, wherein the compression rate is selected by considering a total power to be consumed by the wireless device, wherein the total power to be consumed includes power consumption during wireless transmissions over the current network channel and power consumption during data compression at the compression rate selected, wherein the total power to be consumed at the compression rate selected will minimize the total power consumption used in wirelessly transmitting the data stream over the current network channel.

15. A system comprising:
a compression regulator component configured to select a compression rate that will minimize the total power value used by a wireless device in wirelessly transmitting a data stream over a current network channel; and
a compression module configured to compress the data stream at the compression rate selected.

16. The system of claim 15, comprising:
a video camera coupled to an input of the compression module, wherein the video camera is configured to generate the data stream.

17. The system of claim 16, wherein the compression regulator component obtains information indicative of a current network condition of the current network channel and the compression rate is selected based on the current network condition, wherein the information indicative of current network condition is obtained responsive to receiving at least one of a request to the data stream generated by the video camera.

18. The system of claim 17, further comprising:
a communication network device configured to wirelessly transmit the data stream after having been compressed at the compression rate selected.

19. The system of claim 18, wherein the communication network device is configured to transmit the data stream at a frequency of 60 GHz.

20. The system of claim 19, wherein the compression rate selected indicates that no compression is to be performed.
